(19) United States
(12) Patent Application Publication
(10) Pub. No.: US 2004/0226558 A1
(43) Pub. Date: Nov. 18, 2004

(54) Ventilation system for safety clothing

(76) Inventor: Arnd Kausch, Bad Schwartau (DE)

Correspondence Address: MCGLEW & TUTTLE, PC, 1 SCARBOROUGH STATION PLAZA, SCARBOROUGH, NY, 10510-0827, US

(21) Appl. No.: 10/775,934

(22) Filed: Feb. 9, 2004

(30) Foreign Application Priority Data
May 13, 2003 (DE) 103 15 607.0

(51) Int. Cl. A62B 18/00

(52) U.S. Cl. 128/201.29; 128/201.22; 128/201.23

(57) ABSTRACT

A device for supplying breathing air in the interior of a safety clothing is provided wherein low air flow velocity and low noise is guaranteed so as to prevent drying out of the mucosa of the user, undesired partial cooling and nuisance due to noise. A hose system (3) is provided in the interior of a safety clothing (1), which hose system is connected to a compressed air source and has a tube section designed as a semicircle (5) at the level of the neck part (6). The tube section is sealed in its lower area (7) and made porous in its upper area (8), so that breathing air flows at a low velocity of flow upward to the breathing organs mouth and nose from the tube section.

### FIELD OF THE INVENTION

The present invention relates to a breathing apparatus and pertains more particularly to a system, method and apparatus for supplying breathing air in the interior of a safety clothing.

### BACKGROUND OF THE INVENTION

A ventilation system for safety clothing makes it possible to do without carrying an additional breathing connection besides the safety clothing. It is used during deployments with a duration that is often longer than one hour as well as rescue missions. The device should be robust and able to be operated in a simple manner. The breathing air is supplied, as a rule, by means of compressed air hose devices.

Liquid-proof and gas-proof chemical safety suits used in the industry, which are worn in the necessary combination with an additional breathing connection, e.g., in the form of a breathing mask, and are coupled either with a breathing air filter for use depending on the ambient air or with a compressed air breathing apparatus or compressed air hose device for use independently from the ambient air, are now known. The ergonomics and the safety of operation during the use of these chemical safety suits are greatly reduced by the necessity to supply the user of the device with breathing air via the breathing connection. Cooling of the body can be brought about only by means of ventilating elements built in the chemical safety suit, preferably with compressed air.

The breathing air is usually introduced in a muffled manner. Swirling, which dries out the mucosa of the eyes, mouth and nose, and draft, which may lead to partial cooling, frequently occurs.

An air supply system, especially for safety clothing used for work, is known from EP 1,093,830 A1. The air supply is regulated in this air supply system on the basis of a pressure measurement. An alarm is triggered when the pressure drops below a preset limit. Furthermore, body cooling and a particle prefilter for the compressed air are provided. A muffler is located at the discharge opening for the breathing air. The flow rate of the breathing air is set to be at least so high that the carbon dioxide concentration will be below 1 vol. %. The alarm means for the case of a pressure drop as well as the upper limit of 1 vol. % for the carbon dioxide concentration are standard requirements according to the standard EN 270.

An escape hood with a ring-shaped bank of tubes for the breathing gas reserve is described in DE 26 51 917. A pressure-reducing system and a filling connection within the hood are located between the breathing gas reserve and the bank of tubes.

DE 90 16 491 describes a safety suit with compressed air supply, which may also be used as breathing air. An air inlet for the breathing air is located in the neck area, and an air outlet is arranged by means of a head band in front of the face of a user, and it points downward toward the visor in the head part of the safety suit. Furthermore, outlet valves are provided, which open above a preset value of a low overpressure. A safety helmet is not provided.

A partially high velocity of flow inside a safety clothing proved to be a disadvantage in the prior-art devices for breathing air supply, because it leads to the drying out of the mucosa, to undesired cooling of the affected body parts and to increased nuisance due to noise.

### SUMMARY OF THE INVENTION

The primary object of the present invention is to provide a device for breathing air supply inside a safety clothing, which makes breathing air available with a low velocity of flow and with low noise level.

The object is accomplished with a device for breathing air in the interior of a safety clothing with a connection means to a compressed air source for providing the breathing air, with a hose system. The hose system, from which the breathing air enters the interior of the safety clothing, is connected with this connection means. The hose system comprises tube sections which are made partially porous.

Due to the breathing air entering the interior of the safety clothing from the compressed air source through the porous parts of the tube sections, the breathing air is introduced in an extensively muffled and diffuse manner. The velocity of flow remains low. Moreover, sufficient fresh air supply with a carbon dioxide concentration below preset limits as well as a low noise level and little draft are guaranteed, without a closed loop being necessary for the air supply for this.

In a preferred embodiment, the porous parts of the tube sections are made of a sintered plastic.

In another preferred embodiment, one of the tube sections of the hose system is advantageously designed in the form of a horizontally extending semicircle, located at the level of the neck part of the safety clothing. If the semicircle is made porous in its upper area, i.e., directed toward the head of the user, and it is sealed in its lower area, i.e., directed toward the lower part of the body as viewed by the user, the breathing air rises upward from the tube section designed as a semicircle with a low velocity of flow and thus directly to the breathing organs mouth and nose of the user. Another advantage that arises is that the visor is exposed to a flow of dry air and the visor is thus effectively prevented from fogging.

Distributor hoses, from which the breathing air of the compressed air source flows out of discharge openings that are arranged distributed over the inside of the safety clothing, are provided in a preferred embodiment, which is especially expedient for safety suits that cover the entire body of a user. Additional cooling is achieved as a result for the user. It is conceivable that tube sections of the distributor hoses may also be made partially porous in order to guarantee improved distribution of the breathing air used for the cooling within the safety clothing.

The connection means of the device for a compressed air source is preferably designed for a pressure between 3 bar and 10 bar.

The device advantageously comprises at least one pressure relief valve, from which spent breathing air leaves the safety clothing. Thus, at least one pressure relief valve is located in the rear area of the hood, and the spent breathing air escapes because of the slight overpressure in the interior of the safety clothing.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiments of the invention are illustrated.

### BRIEF DESCRIPTION OF THE DRAWINGS

FIG. 1 is a front top view of the cross section of a chemical safety suit supplied with compressed air;

FIG. 2 is a front top view of the cross section of a safety hood supplied with compressed air; and

FIG. 3 is a perspective front view of the head part of a safety clothing.

### DESCRIPTION OF THE PREFERRED EMBODIMENTS

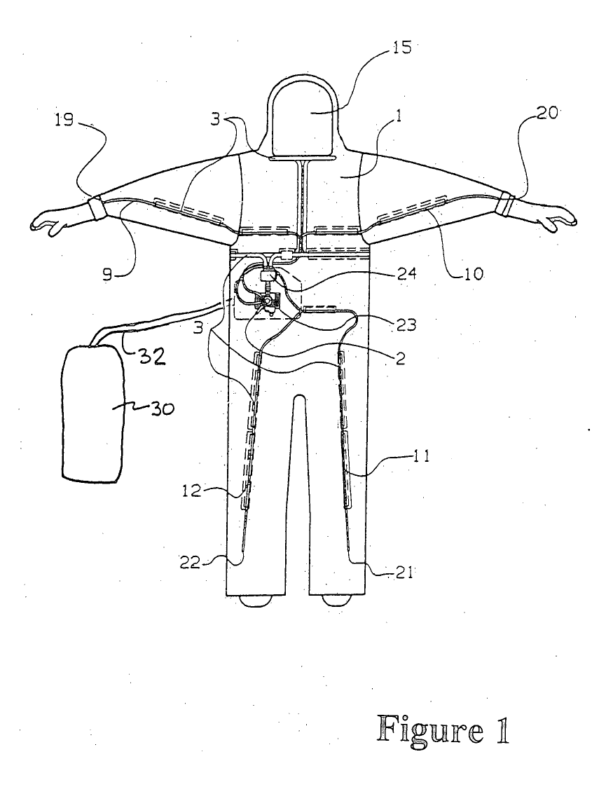

Referring to the drawings in particular, FIG. 1 shows the front top view of the cross section of a safety clothing 1 designed as a chemical safety suit supplied with compressed air via a compressed air source 30. A connection means 2 establishes the connection with the compressed air source 30 via a connection line 32. A hose system 3 is connected to the connection means 2 via a compressed air distributor block 24. A plurality of filter stages for filtering the compressed air may be provided within the compressed air distributor block 24.

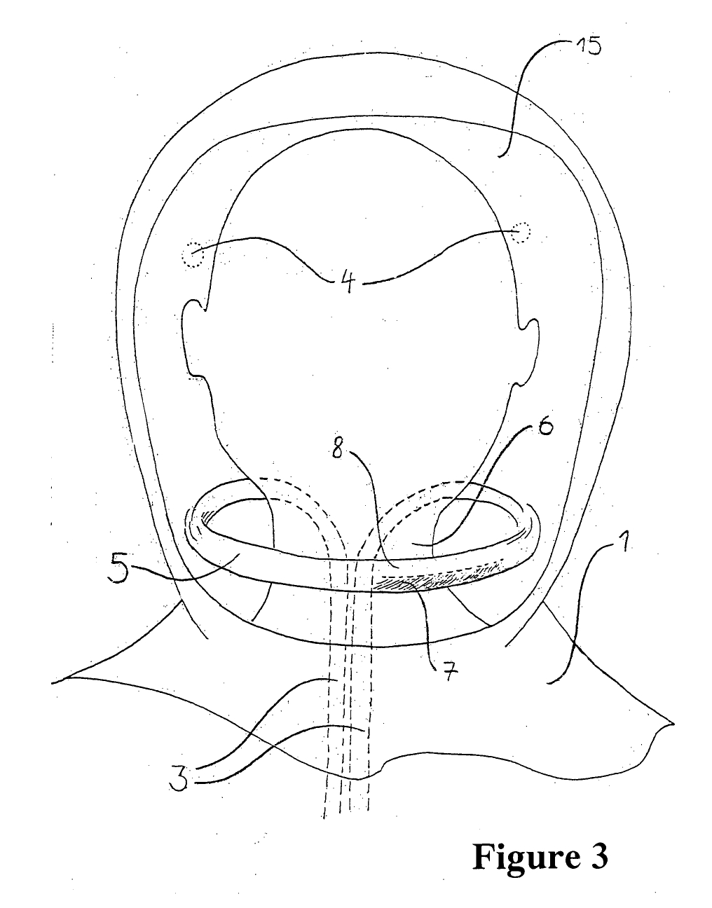

The hose system 3 comprises a tube section for breathing gas supply in the head part, which is visibly indicated by a visor 15 and is explained in greater detail in FIG. 3. The hose system 3 comprises, furthermore, distributor hoses 9, 10, which are used for cooling, extend along the two arms of the chemical safety suit and have a discharge opening 19, 20 each at their ends. Distributor hoses 11, 12 extend correspondingly along the two trouser legs for cooling and have respective discharge openings 21, 22 at their ends. A warning whistle 23 is used to send an alarm signal in the event that the air flow for the breathing air supply and, moreover, for the cooling drops below a preset value during the operation of the device.

Identical features of the device will be designated below by the same reference numbers and will not be explained separately.

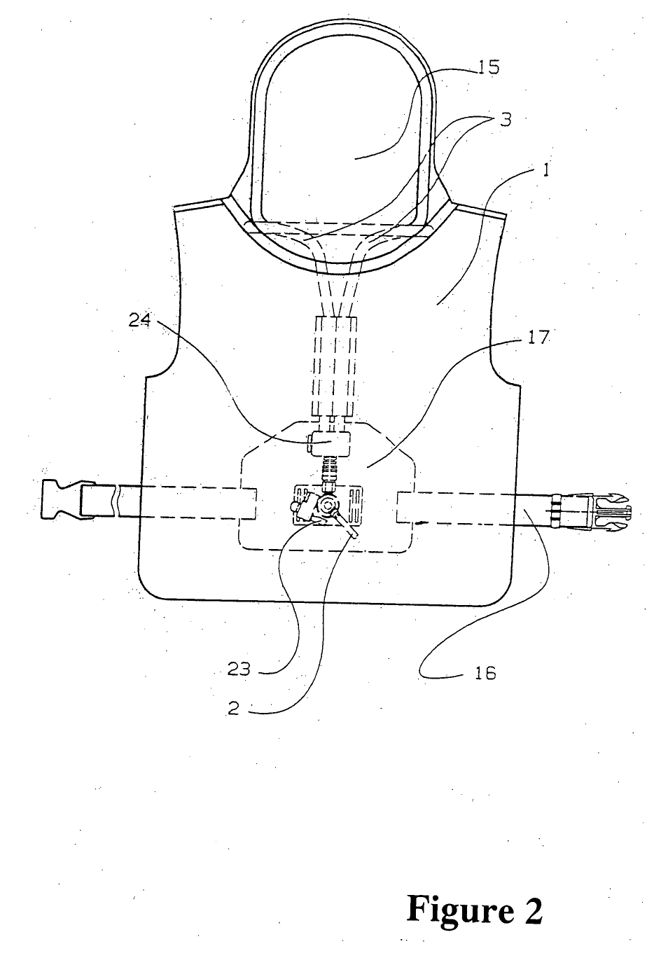

FIG. 2 shows a front top view of the cross section of a safety clothing 1 designed as a safety hood supplied with compressed air. A hose system 3 is used here primarily for breathing gas supply. The safety hood has a back padding 17 for the user, which is indicated by broken lines, because it is located behind the plane of the cross section when viewed by the viewer. A belt 16 with a snap is used to fasten a safety hood.

FIG. 3 shows a perspective front view of the head part of a safety clothing 1, e.g., a safety suit or a safety hood. A tube section of the hose system 3 is arranged here in the form of a horizontally extending semicircle 5 at the level of the neck part 6 of a user of the safety clothing 1. The semicircle 5 is designed as a bent plastic tube, which is sealed in its lower area 7, which is indicated partially by shading, and is porous, i.e., permeable to the breathing air flowing in from the compressed air distributor block 24, in its upper area 8. Pressure relief valves 4 are indicated by broken lines and are located in the rear area of the hood of the safety clothing 1.

While specific embodiments of the invention have been shown and described in detail to illustrate the application of the principles of the invention, it will be understood that the invention may be embodied otherwise without departing from such principles.

What is claimed is:

1. A device for supplying breathing air in an interior of a safety clothing, the device comprising:
a connection means to a compressed air source for providing breathing air;
a hose system which is connected to said connection means from which breathing air enters said interior of said safety clothing, wherein said hose system further comprises a permeable tube section made porous.

2. A device in accordance with claim 1, wherein porous part of said permeable tube section is made of a sintered plastic.

3. A device in accordance with claim 1, wherein said permeable tube section is formed in a horizontally extending semicircle and is placed at level of a neck part of a user of said safety clothing.

4. A device in accordance with claim 3, wherein said horizontally extending semicircle further comprises a lower area and an upper area wherein said lower area is sealed and said upper area is porous.

5. A device in accordance with claim 1 further comprising distributor hoses, each of said distributor houses having a discharge opening from which breathing air of a compressed air source flows out, said distributor hoses being arranged distributed over said inside of said safety clothing.

6. A device in accordance with claim 1, wherein said connection means is for a compressed air source which is operated with a pressure of 3 bar to 10 bar.

7. A device in accordance with claim 1, further comprising a hood part connected to a body part of said safety clothing, said hood having a rear area wherein a pressure relief valve is arranged in said rear area of said hood.

8. A device to minimize mucosa-drying pressure and noise nuisance while delivering breathing air in an interior of a safety clothing, the device comprising:
a compressed air source;
a hose system for delivering breathing air in the safety clothing, said hose system including a porous gas permeable tubular section;
a connection between said hose system and said compressed air source wherein the breathing air from said compressed air source enters the interior of the safety clothing through said hose system.

9. A device in accordance with claim 8, wherein porous part of said permeable tubular section is made of a sintered plastic.

10. A device in accordance with claim 8, wherein said permeable tubular section is formed in a horizontally extending semicircle and is placed at level of a neck part of a user of said safety clothing.

11. A device in accordance with claim 10, wherein said horizontally extending semicircle further comprises a lower area and an upper area wherein said lower area is sealed and said upper area is porous.

12. A device in accordance with claim 8 further comprising a distributor hose having a discharge opening from which breathing air of compressed air source flows out from said discharge opening, which are arranged distributed over said inside of said safety clothing.

13. A device in accordance with claim 8, wherein said connection means is for a compressed air source which is operated with a pressure of 3 bar to 10 bar.

14. A device in accordance with claim 8, further comprising a hood part connected to a body part of said safety clothing, said hood having a rear area wherein a pressure relief valve is arranged in said rear area of said hood.

15. A method for minimizing mucosa-drying pressure and noise nuisance while delivering breathing air supply in an interior of a safety clothing, the method comprising the steps of:
providing a safety clothing;
providing a compressed air source
providing a breathing air delivery unit with a porous gas permeable tubular section;
providing a connection from said compressed air source to said breathing air delivery means;
delivering a breathing air from said compressed air source through said connection to said breathing air delivery unit and to an interior of said safety clothing and through pores of said porous gas permeable tubular section.
